(19) United States
(12) Patent Application Publication
(10) Pub. No.: US 2022/0381476 A1
(43) Pub. Date: Dec. 1, 2022

(54) A HEAT EXCHANGER COLLECTOR CONFIGURATION

(71) Applicant: GRON ISITMA SOGUTMA LIMITED SIRKETI, Kirsehir (TR)

(72) Inventor: Hasan Huseyin Eraslan, Kirsehir (TR)

(21) Appl. No.: 17/769,947

(22) PCT Filed: Nov. 23, 2020
(86) PCT No.: PCT/TR2020/051147

§ 371 Date: Apr. 18, 2022

(30) Foreign Application Priority Data
Oct. 18, 2019 (TR) 2019/16134

(51) Int. Cl. F24H 1/43; F24H 8/00; F28D 1/047; F28F 9/02

(52) U.S. Cl. CPC F24H 1/43; F24H 8/00; F28D 1/0473; F28F 9/0204

(57) ABSTRACT

The invention is related to a heat exchanger collector configuration (1) allowing more efficient heat distribution within double-helix heat exchangers of heating systems by connecting the outer helix (14) with the inner helix (13) and minimizing the heat loss of water circulating within the helices. Thanks to the heat exchanger collector configuration (1), the inner helix (13) can be connected to the outer helix (14) without any deformation on its full circular structure. As the full circular structure of the inner helix (13) is not deformed, heat formed within the combustion chamber inside of the inner helix (13) is distributed equally over the helix and thereby, efficiency of heat absorption is increased.

### TECHNICAL FIELD

The invention is related to a heat exchanger collector configuration allowing more efficient heat distribution within double-helix heat exchangers of heating systems by connecting the outer helix with the inner helix and minimizing the heat loss of water circulating within the helices.

Thanks to the heat exchanger collector configuration, the inner helix can be connected to the outer helix without any deformation on its full circular structure. As the full circular structure of the inner helix is not deformed, heat formed within the combustion chamber inside of the inner helix is distributed equally over the helix and thereby, efficiency of heat absorption is increased.

### STATE OF THE ART

Today, two main types of heat exchanger are commonly used. One of them is the fire-tube heat exchanger placed over the combustion chamber. In this type of heat exchanger, the fire circulates within the tubes and heats the water chamber around the tubes. These heat exchangers keep higher amount of water mass within their body, hence do have heavier weight. Furthermore, the material used is thicker and heavier as the fire circulates inside of these heat exchangers.

Another type is the water-tube heat exchangers. In this type of heat exchanger, water flows within the tubes and enables heat transfer only when passing through the burning gas pipes. Therefore, the amount of water within the heat exchanger is less and the material used is thinner as the tubes are not exposed to direct flame. Therefore, water-tube heat exchangers are widely used today.

The United States patent document numbered US 2019 0024942 explains a heat exchanger having double-helix structure. In this heat exchanger, outer helix and inner helix are connected via a collector. The geometrical structure of the outer and inner helices comprises of pipes in C form. This C form allows placing the collector on its edges to connect the outer and inner helices by which it enables distribution of water inside of the helices. However, more heat is absorbed with this collector which does not increase the efficiency.

A collector configuration wherein the helical structure of the heat exchanger allows heat absorption by enabling connection of inner helix with the outer one without deformation of complete circular structure of the inner helix is not mentioned in the aforementioned documents.

### DESCRIPTION OF FIGURES

The heat exchanger collector configuration developed to achieve the purposes of this invention is shown in attached figures.

In these figures:

FIG. 1. The view of the heat exchanger collector configuration of the present invention placed on outer and inner helices.

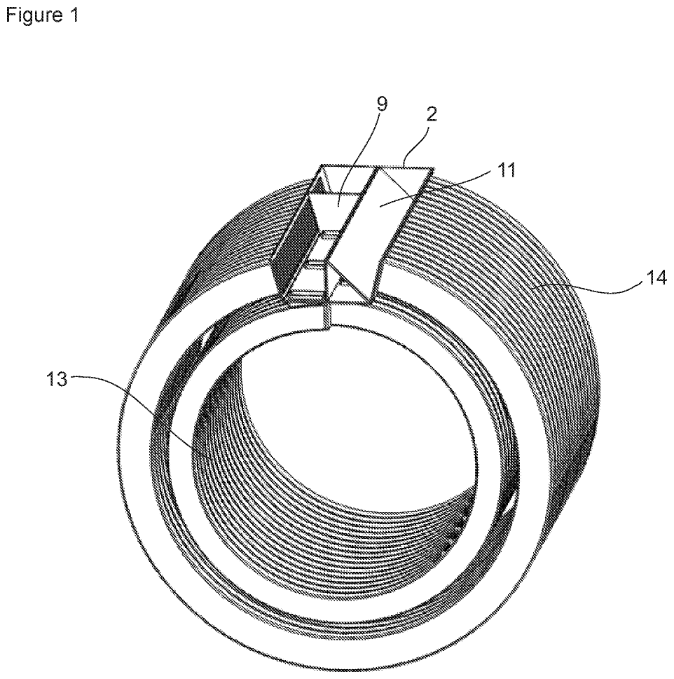

FIG. 2. The back view of the heat exchanger collector configuration of the present invention placed on outer and inner helices.

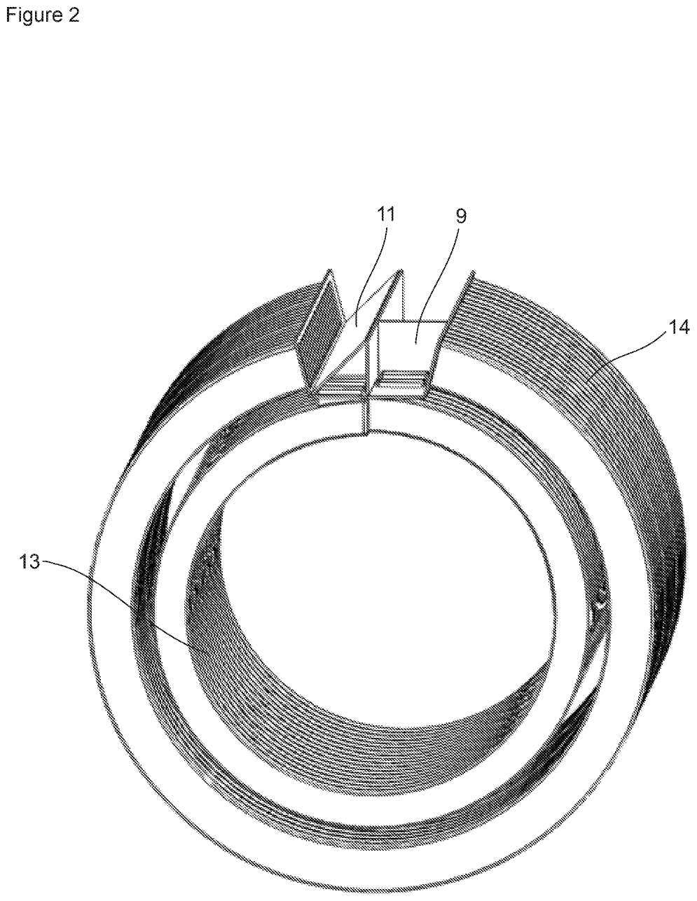

FIG. 3. The front view of the heat exchanger collector configuration of the present invention placed on outer and inner helices.

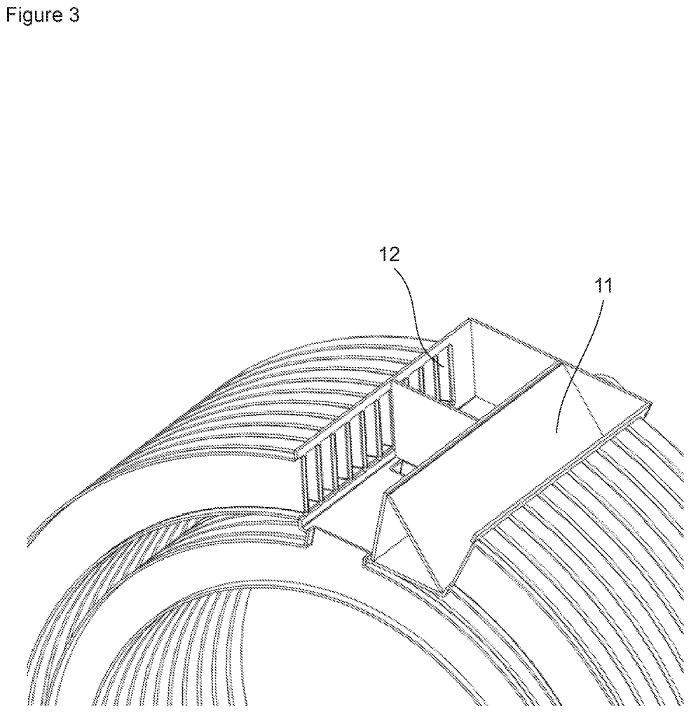

FIG. 4. The view of the heat exchanger collector configuration of the present invention closed with a plate.

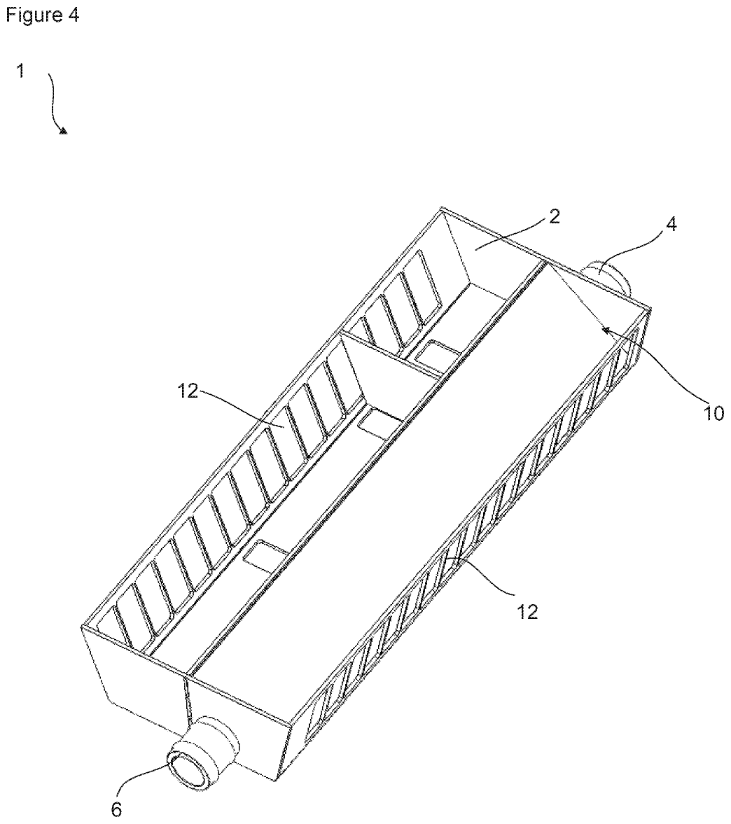

FIG. 5. The inner sectional view of the heat exchanger collector configuration of the present invention.

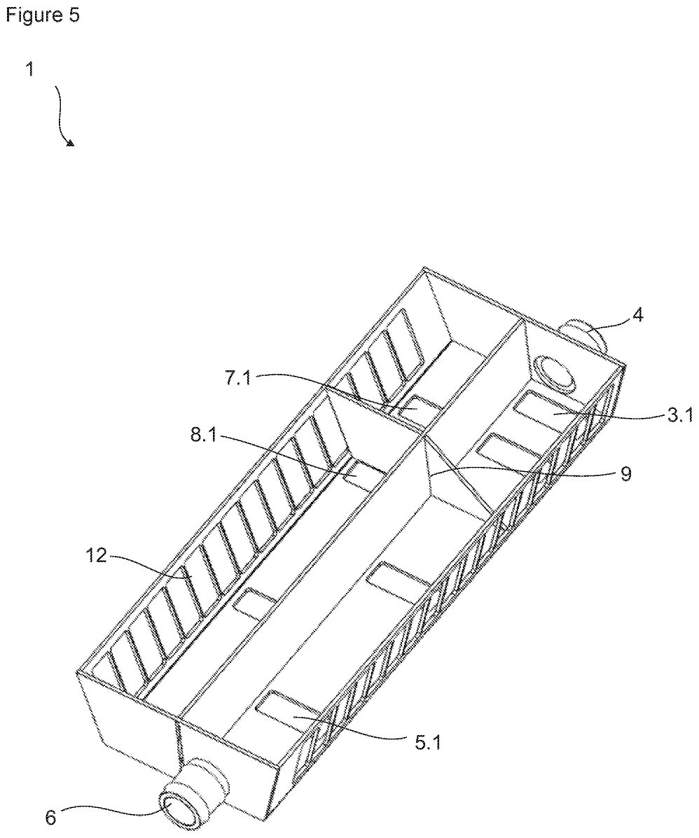

FIG. 6. The top view of the heat exchanger collector configuration of the present invention.

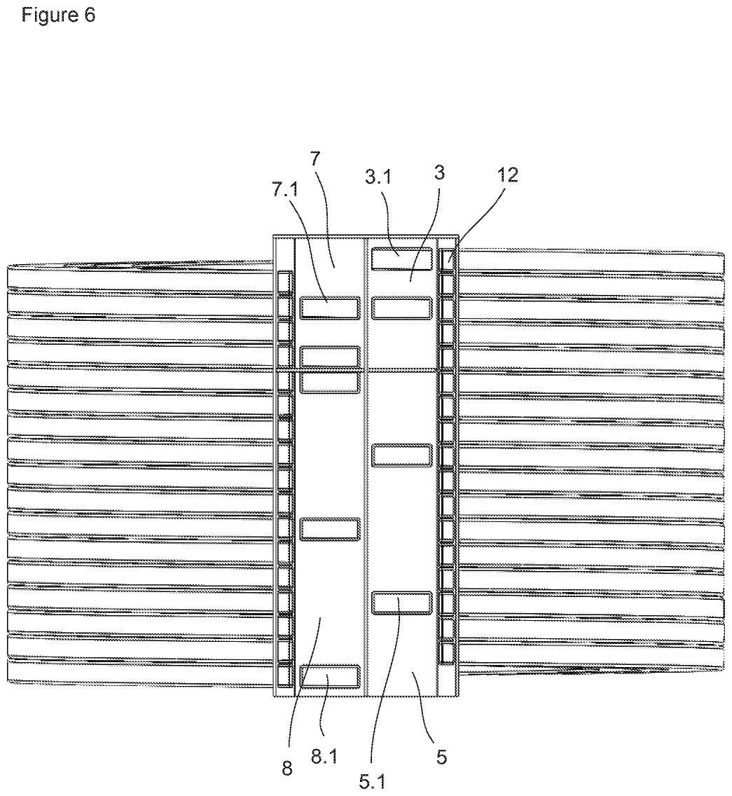

Parts constituting the invention are numbered as follows in attached figures:
1—Heat exchanger collector configuration
2—Body
3—First chamber
   3.1 First chamber holes
4—Inlet
5—Second chamber
   5.1 Second chamber holes
6—Outlet
7—Third chamber
   7.1 Third chamber holes
8—Fourth chamber
   8.1 Fourth chamber holes
9—Separator
10—Fifth chamber
11—Plate
12—Window
13—Inner helix
14—Outer helix

A heat exchanger collector configuration (1) of the present invention comprising of;
A body (2)
An inlet (4) on the first chamber (3) side of the body (2) where cold water enters into the collector (1)
An outlet (6) on the second chamber (5) side of the body (2) where hot water flows into the heating systems through the collector (1)
A separator (9) on the body (2) dividing the base of the body (2) into four sections in different geometry, namely, the first chamber (3), second chamber (5), third chamber (7) and fourth chamber (8)
A plate (11) forming the fifth chamber (10) by placing its long side on the separator (9) in a manner that this long side will be on the upper side of the first chamber (3) and the second chamber (5), and by placing other long side curvedly on the base of the body (2)
At least four windows (12) with same geometrical structures placed on both long side of the body (2) and allowing flow of water between the helices
First chamber (3) having at least two first chamber holes (3.1) which captures the water flowing through the inlet (4) and enables flow of water to the inner helix (13) with its downstream movement
Third chamber (7) enabling entry of the water into its body via upstream movement of water circulating within the inner helix (13), comprising of at least two third chamber holes (7.1) and enabling flow of water to the outer helix (14) from the windows (12) on the same line
Fifth chamber (10) enabling entry of water circulating within the outer helix (14) through the windows (12) on the inlet (4) side and then, its exit via the windows (12) on the outlet (6) by contacting the plate (11) and finally, flow of water into the outer helix
Fourth chamber (8) comprising of at least three fourth chamber holes (8.1) enabling flow of water circulating inside of the outer helix (14) into the inner helix (13) by way of its downstream movement
Second chamber (5) comprising of at least two second chamber holes (5.1), allowing entry of water circulating within the inner helix (13) inside of its body via its upstream movement and transferring the heated water trapped within its body to the outlet (6).

The heat exchanger collector configuration (1) of the present invention ensures flow of water from cold side to the hot side continuously and flow of gas from hot side to the cold side as an outcome of which revers flow is ensured and heat of the gas is transferred to water.

The main characteristic and aim of the heat exchanger collector configuration (1) of the present invention is to transfer heat within the burning gas into the heating fluid before release of the gas into the atmosphere by ensuring maximum condensation. Thereby, condensation is achieved by transferring overall heat of the gas to the fluid and creating an efficient heat transfer surface.

The heat exchanger collector configuration (1) of the present invention comprises of two helical structures of same centers, namely, the inner helix (13) and the outer helix (14). The inner helix (13) and the outer helix (14) gaps are aligned on the same line, which ensures easier gas outflow. Furthermore, this helical structure has curved shape that increases heat transfer.

Due to the fact that the complete helical structure of the inner helix (13) is not deformed, rate of heat absorption within the burning chamber is higher.

Water is heated by flowing through areas having different heats continuously and water heated in different areas is not mixed with each other in this heat exchanger collector configuration (1) of the present invention. Thereby, outlet temperature is balanced.

Since helical structures within the heat exchanger are connected by way of a common collector, heat transfer is sustained even though one of the windings is blocked.

Water pressure resistance loss is minimized by collecting water within sections in this heat exchanger collector configuration (1) of the present invention. Besides, special shape of the tubes allows increase of heat absorption by curving inward in reverse direction to the incoming gas surface.

1- A heat exchanger collector configuration (1) of the present invention comprising of a body (2); an inlet (4) on the first chamber (3) side of the body (2) where cold water enters into the collector (1); an outlet (6) on the second chamber (5) side of the body (2) where hot water flows into the heating systems through the collector (1); and characterized in that the present invention comprises a separator (9) on the body (2) dividing the base of the body (2) into four sections in different geometry, namely, the first chamber (3), second chamber (5), third chamber (7) and fourth chamber (8), and a plate (11) forming the fifth chamber (10) by placing its long side on the separator (9) in a manner that this long side will be on the upper side of the first chamber (3) and the second chamber (5), and by placing other long side curvedly on the base of the body (2), and at least four windows (12) with same geometrical structures placed on both long side of the body (2) and allowing flow of water between the helices, and first chamber (3) having at least two first chamber holes (3.1) which captures the water flowing through the inlet (4) and enables flow of water to the inner helix (13) with its downstream movement, and third chamber (7) enabling entry of the water into its body via upstream movement of water circulating within the inner helix (13), comprising of at least two third chamber holes (7.1) and enabling flow of water to the outer helix (14) from the windows (12) on the same line, and fifth chamber (10) enabling entry of water circulating within the outer helix (14) through the windows (12) on the inlet (4) side and then, its exit via the windows (12) on the outlet (6) by contacting the plate (11) and finally, flow of water into the outer helix, and fourth chamber (8) comprising of at least three fourth chamber holes (8.1) enabling flow of water circulating inside of the outer helix (14) into the inner helix (13) by way of its downstream movement, and second chamber (5) comprising of at least two second chamber holes (5.1), allowing entry of water circulating within the inner helix (13) inside of its body via its upstream movement and transferring the heated water trapped within its body to the outlet (6).
